(19) United States
(12) Patent Application Publication
(10) Pub. No.: US 2025/0077903 A1
(43) Pub. Date: Mar. 6, 2025

(54) TRANSFORMING COUNTERFACTUALS FOR DOMAIN CONSTRAINTS

(71) Applicant: INTERNATIONAL BUSINESS MACHINES CORPORATION, ARMONK, NY (US)

(72) Inventors: Shivaram Subramanian, Frisco, TX (US); Wei Sun, Scarsdale, NY (US); Youssef Drissi, Peekskill, NY (US); Markus Ettl, Yorktown Heights, NY (US); Zhengliang Xue, Yorktown Heights, NY (US)

(21) Appl. No.: 18/459,377

(22) Filed: Aug. 31, 2023

(51) Int. Cl. G06N 5/022

(52) U.S. Cl. CPC G06N 5/022

(57) ABSTRACT

A computer product and methodology is contemplated for training a first machine learning model with a first set of data to generate a response function. The first set of data is partitioned into action features and non-action features. The response function includes factual output values and raw counterfactual output values. The response function is discretized into segments based on one or more of the non-action features of the first set of data. A second machine learning model is trained using a first segment of the segments and using a domain constraint on raw counterfactual output values of the first segment. The second machine learning model produces, as output, transformed counterfactual values.

### BACKGROUND

The present disclosure generally relates to machine learning, and more particularly but not by way of limitation, to systems and methods of transforming counterfactual predictions to conform to user-defined domain constraints.

### SUMMARY

According to an embodiment of the present disclosure, a computer-implemented method is provided for training a first machine learning model with a first set of data to generate a response function. The first set of data is partitioned into action features and non-action features. The response function includes factual output values and raw counterfactual output values. The response function is discretized into segments based on one or more of the non-action features of the first set of data. A second machine learning model is trained using a first segment of the segments and using a domain constraint on raw counterfactual output values of the first segment. The second machine learning model produces, as output, transformed counterfactual values.

In one embodiment, which may be combined with the preceding embodiment, a computer program product is provided for conforming counterfactual predictions to domain constraints. The computer program product includes a computer readable storage medium having program instructions embodied therewith. The program instructions are executable by a processor to cause a computing device to train a first machine learning model with a first set of data to generate a response function and to partition the data into action features and non-action features. The response function includes factual output values and raw counterfactual output values. The response function is discretized into segments based on one or more of the non-action features of the first set of data. A second machine learning model is trained using a first segment of the segments and using a domain constraint on raw counterfactual output values of the first segment. The second machine learning model produces, as output, transformed counterfactual values.

In one embodiment, a computer system is provided for transforming counterfactual predictions to conform to domain constraints. The computer system includes one or more processors, one or more computer-readable memories, one or more computer-readable tangible storage devices, and program instructions stored on at least one of the one or more storage devices for execution by at least one or more of the processors via at least one of the one or more memories. The computer system is capable of performing a method of training a first machine learning model with a first set of data to generate a response function and to partition the data into action features and non-action features. The response function includes factual output values and raw counterfactual output values. The response function is discretized into segments based on one or more of the non-action features of the first set of data. A second machine learning model is trained using a first segment of the segments and using a domain constraint on raw counterfactual output values of the first segment. The second machine learning model produces, as output, transformed counterfactual values.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram illustration of a computer hardware platform for efficiently transforming counterfactual predictions to conform to domain constraints and that can communicate with various networked components, consistent with an illustrative embodiment.

FIG. 2 is a conceptual block diagram of a counterfactual transformation engine in the computer hardware platform of FIG. 1, consistent with an illustrative embodiment.

FIG. 3 is a conceptual block diagram of the machine learning resources in the computer hardware platform of FIG. 1, consistent with an illustrative embodiment.

FIG. 4 graphically depicts a counterfactual response function which escapes a domain constraint and is transformable using techniques described herein.

FIG. 5a graphically depicts another counterfactual response function, according to alternative embodiments, that conforms to a U-shape domain constraint.

FIG. 5b graphically depicts another counterfactual response function, according to alternative embodiments, which escapes a U-shape domain constraint and is transformable using techniques described herein.

FIG. 6 is another conceptual block diagram of the counterfactual transformation engine in the computer hardware platform of FIG. 1, consistent with an illustrative embodiment.

FIG. 7 diagrammatically depicts discretized segments of the counterfactual response function of FIG. 4 stored to a computer memory, consistent with an illustrative embodiment.

FIG. 8 diagrammatically depicts function predictions including raw counterfactual predictions, factual predictions, weights for the factual predictions, and counterfactual weights for the counterfactual response function of FIG. 4 stored to a computer memory, consistent with an illustrative embodiment.

FIG. 9 graphically depicts raw counterfactual predictions for the counterfactual response function of FIG. 4, consistent with an illustrative embodiment.

FIG. 10 graphically depicts the raw counterfactual predictions of FIG. 9 transformed to conform to domain constraints, consistent with an illustrative embodiment.

FIG. 11 graphically depicts a calibration curve for further refining the transformed counterfactual predictions of FIG. 10, consistent with an illustrative embodiment.

FIG. 12 graphically depicts a calibrated counterfactual transformation model for the counterfactual response function of FIG. 4, consistent with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

To better understand the features of the present disclosure, it may be helpful to discuss known architectures. To that end, the following detailed description illustrates various aspects of the present disclosure by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

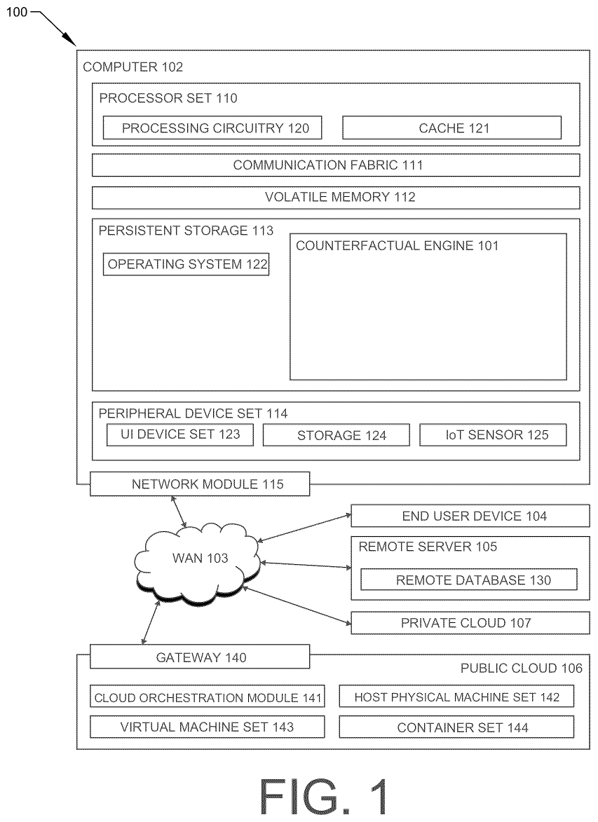

Referring to FIG. 1, computing environment 100 includes an example of an environment for the execution of at least some of the computer code involved in performing the inventive methods, including a counterfactual transformation (“CFX”) engine block 101. In addition to block 101, computing environment 100 includes, for example, computer 102, wide area network (WAN) 103, end user device (EUD) 104, remote server 105, public cloud 106, and private cloud 107. In this embodiment, computer 102 includes processor set 110 (including processing circuitry 120 and cache 121), communication fabric 111, volatile memory 112, persistent storage 113 (including operating system 122 and block 101, as identified above), peripheral device set 114 (including user interface (UI) device set 123, storage 124, and Internet of Things (IoT) sensor set 125), and network module 115. Remote server 105 includes remote database 130. Public cloud 106 includes gateway 140, cloud orchestration module 141, host physical machine set 142, virtual machine set 143, and container set 144.

COMPUTER 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 102 to cause a series of operational steps to be performed by processor set 110 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 101 in persistent storage 113.

COMMUNICATION FABRIC 111 is the signal conduction path that allows the various components of computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 102, the volatile memory 112 is located in a single package and is internal to computer 102, but, alternatively or additionally, the volatile memory may be distributed over multiple packages and/or located externally with respect to computer 102.

PERSISTENT STORAGE 113 is any form of non-volatile storage for computers that is now known or to be developed in the future. The non-volatility of this storage means that the stored data is maintained regardless of whether power is being supplied to computer 102 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 101 typically includes at least some of the computer code involved in performing the inventive methods.

PERIPHERAL DEVICE SET 114 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 102 to communicate with other computers through WAN 103. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 102 from an external computer or external storage device through a network adapter card or network interface included in network module 115.

WAN 103 is any wide area network (for example, the internet) capable of communicating computer data over non-local distances by any technology for communicating computer data, now known or to be developed in the future. In some embodiments, the WAN 103 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 104 is any computer system that is used and controlled by an end user (for example, a customer of an enterprise that operates computer 102), and may take any of the forms discussed above in connection with computer 102. EUD 104 typically receives helpful and useful data from the operations of computer 102. For example, in a hypothetical case where computer 102 is designed to provide a recommendation to an end user, this recommendation would typically be communicated from network module 115 of computer 102 through WAN 103 to EUD 104. In this way, EUD 104 can display, or otherwise present, the recommendation to an end user. In some embodiments, EUD 104 may be a client device, such as thin client, heavy client, mainframe computer, desktop computer and so on.

REMOTE SERVER 105 is any computer system that serves at least some data and/or functionality to computer 102. Remote server 105 may be controlled and used by the same entity that operates computer 102. Remote server 105 represents the machine(s) that collect and store helpful and useful data for use by other computers, such as computer 102. For example, in a hypothetical case where computer 102 is designed and programmed to provide a recommendation based on historical data, then this historical data may be provided to computer 102 from remote database 130 of remote server 105.

PUBLIC CLOUD 106 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 106 is performed by the computer hardware and/or software of cloud orchestration module 141. The computing resources provided by public cloud 106 are typically implemented by virtual computing environments that run on various computers making up the computers of host physical machine set 142, which is the universe of physical computers in and/or available to public cloud 106. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 106 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 107 is similar to public cloud 106, except that the computing resources are only available for use by a single enterprise. While private cloud 107 is depicted as being in communication with WAN 103, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 106 and private cloud 107 are both part of a larger hybrid cloud.

The computer 102 is in some embodiments a server. The remote server 105 in some embodiments represents multiple servers which provide machine learning resources and/or computer memory resources for the computer 102 and the counterfactual engine 101.

“Machine learning” broadly describes a function of an electronic system that learns from data. A machine learning system, engine, or module can include a trainable machine learning algorithm stored in computer memory that can be trained, such as in an external cloud environment, to learn functional relationships between inputs and outputs that are currently unknown.

Machine learning can be utilized to solve a variety of technical issues (e.g., learning previously unknown functional relationships) in connection with technologies such as, but not limited to, machine learning technologies, time-series data technologies, data analysis technologies, data classification technologies, data clustering technologies, trajectory/journey analysis technologies, medical device technologies, collaborative filtering technologies, recommendation system technologies, signal processing technologies, word embedding technologies, topic model technologies, image processing technologies, video processing technologies, audio processing technologies, and/or other digital technologies.

Accordingly, the computer 102 has a specialized processing unit such as the CFX engine 101 and the like for carrying out computations related to machine learning. More particularly, without limitation, the specialized processing unit transforms counterfactual predictions to conform to user-defined domain constraints, such as monotonicity constraints. The computer system is thereby specifically configured to provide technical improvements to data systems, machine learning systems, artificial intelligence systems, and systems of data analysis systems such as but not limited to data classification systems, data regression systems, data clustering systems, and the like. The machine learning output can further provide one or more inferences, provide one or more predictions, and/or determine one or more relationships among the data. For example, counterfactuals as described herein may model one or more inferences and/or predictions and/or may determine one or more relationships amongst the variables analyzed in the data. A machine learning model is produced that is as accurate as traditional machine learning models for predicting outputs, e.g., probabilities, at factual (historical) action values from a training dataset of historical data. The machine learning model that is produced is, however, far more accurate than traditional machine learning models for predicting outputs, e.g., probabilities, at counterfactual values for which there were no samples in the historical training dataset. Thus, the machine learning model that is produced helps with downstream decision making, even with such downstream decision making that is automated. The techniques described herein allow a successful model training with a smaller historical training dataset because the techniques allow for more trustworthy counterfactual data to be produced using the counterfactual transformation described herein.

The machine learning resources can employ any suitable machine-learning based techniques, statistical-based techniques and/or probabilistic-based techniques. For example, the machine learning resources can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, and the like. For example, the machine learning resources can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of support vector regression machine learning computations, a set of k-means machine learning computations, a set of spectral clustering machine learning computations, Gaussian mixture model machine learning computations, a set of regularization machine learning computations, a set of rule machine learning computations, a set of Bayesian machine learning computations, a set of deep Boltzmann machine computations, a set of deep belief network computations, a set of convolution neural network computations, a set of stacked auto-encoder computations and/or a set of different machine learning computations.

Accordingly, the distributed computing system generally facilitates machine learning of counterfactual probability predictions in accordance with one or more embodiments illustratively described herein. For example, the counterfactual probability predictions can be related to a machine learning system, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a machine learning process by improving processing performance of the computer processing unit, reducing computing bottlenecks of the computer processing unit, improving processing efficiency of the computer processing unit, and/or reducing an amount of time for the computer processing unit to perform the machine learning process.

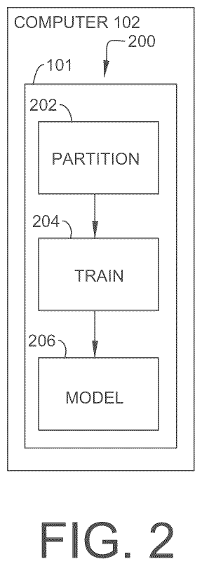

FIG. 2 depicts a block diagram of steps in a process 200 of deriving counterfactual predictions from a set of data. For an illustrative example, the process 200 can be employed to analyze historical data concerning an airline's ticket upgrade offerings. The airline offers upsell choices to its customers during a purchase transaction, such as offers to upgrade the ticket being purchased to a premium economy class seat, or a business class seat, or a first class seat. The distribution of historical conversions can be in a narrow range with few price points. Historical prices tend to be static with minimal variation across customers.

Modern personalized pricing goes far beyond the ranges and offer points of past pricing practices. For example, today price discounts are offered for early bookings typically associated with leisure travel, while price increases are levied for same-day bookings typically associated with business travel. In this example, the airline now desires to make new upsell offers at price points that have not been made before and are therefore not reflected by the historical data.

But counterfactual predictions, or predictions based on data not represented by the data set, can be inaccurate to the point that they violate user-defined domain constraints. Monotonicity constraints, for example, generally provide that ticket demand monotonically decreases with increases in the airline's prices, yet that the airline's prices monotonically increase with increasing prices of competitive offerings from others in a marketplace. Monotonicity restraints also generally provide that the continual raising of prices sharply reduces conversion probability. Monotonicity refers to a function that has the property of either never increasing or never decreasing as the values of the independent variable(s) increase. A monotonic function may have increasing portions and not-changing portions, but no decreasing portions. Another monotonic function may have decreasing portions and not-changing portions but no increasing portions.

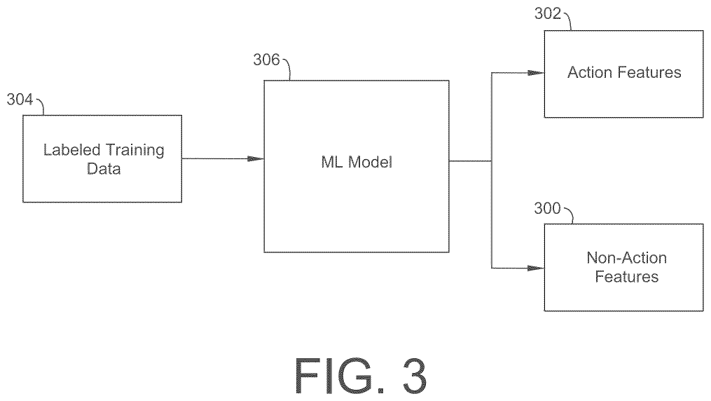

The process 200 can begin in block 202 by partitioning a machine learning space into a non-action feature space and an action feature space. For purposes of this illustrative example, FIG. 3 diagrammatically depicts a large dimensional non-action space 300 that can include customer features from the data set such as the customers' age, sex, residence, number of prior ticket purchases, and the like. The non-action space can also include trip features such as date of flight, ticket price, origin, destination, and the like. The low dimensional action space 302 can include the upsell price offers for one or more upgrade choices available. For the present illustrative example, the action values yᵢⱼ=1 represent instances when the customer (indexed by ‘i’) purchased a ticket upgrade for choice ‘j’ (a conversion) and yᵢⱼ=0 (for all ‘j’) represent instances when the customer did not purchase a ticket upgrade for any of the available upgrades. The action space can include the downstream conversions to multiple upsell offers such as for a premium-economy upgrade, a business-class upgrade, and a first-class upgrade. The partitioning occurs as a result of using labelled training data to train the machine learning model. The set of data that is used to train the first machine learning model includes at least some labels that identify the action features and that identify the non-action features. Thus, the partitioning is part of the block 204 of supervised training the machine learning model, in so far as the identification via labelling of features in the data set as being action features or non-action features.

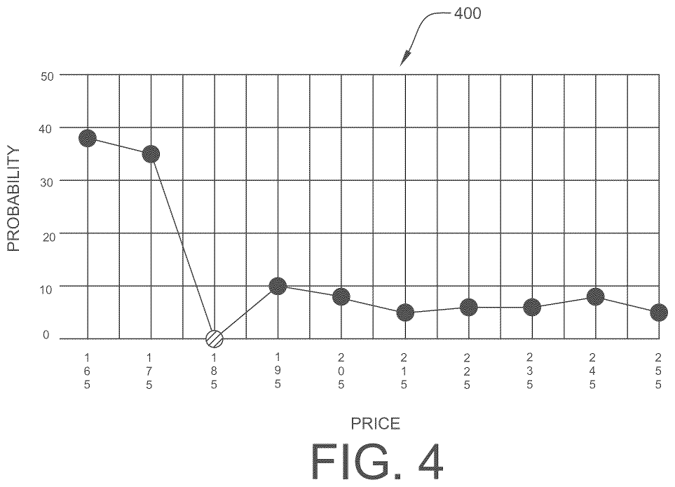

Returning to FIG. 2, in block 204 a machine learning mode is trained with the set of historical data to predict intervention outcomes as a function of the action features and the non-action features. Training can model a function in block 206 that reflects selected non-action features, either individually or grouped. For example, FIG. 4 depicts an aggregate price response function 400 reflecting the probability of conversion in relation to the upsell offer price. In this example, the sparse historical data is a narrow range from $165 to $255. Further, the historical data has only a few factual data points distributed in $10 increments. That is, historical data only exists for nine of the ten price points depicted in FIG. 4. There is no factual data for the $185 price point. The price response function 400 appears to violate monotonicity constraints at the $185 price point. There, the price response function 400 predicts zero probability, even though predicting higher probabilities at both adjacent factual data points of $175 and $195. The response function includes factual output values and counterfactual output values.

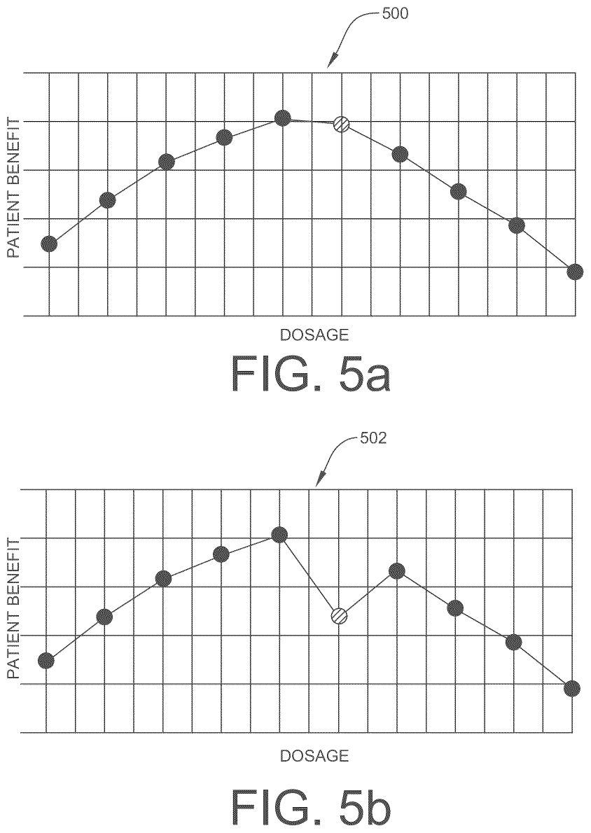

In another embodiment besides the monotonicity constraints, FIG. 5a graphically depicts another response function 500 that follows a U-shape domain constraint. For example, if one of the outputs is a dosage of substance to administer to a patient, as the dosage increases, starting from zero, a benefit of the dosage increases up to a summit. After the summit, further increasing the dosage decreases the benefit and has a diminishing effect on the benefits. Eventually, further increasing the dosage could cause negative effects for the patient. FIG. 5b, however, depicts a response function 502 from another batch of historical data that escapes the U-shape domain constraint like the response function 400 in FIG. 4.

Other embodiments include constraints related to inventory levels, advertisement placement locations, etc.

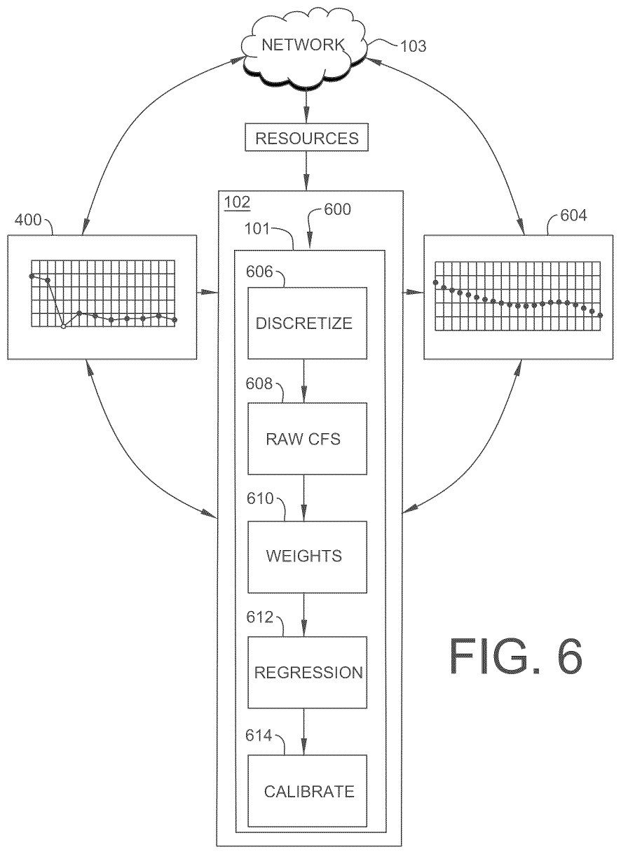

Returning to the present illustrative example, FIG. 6 is a block diagram depicting the price response function 400 having been sent via the network 103 to the computer 102 for processing. The computer 102 can be provided with processing resources via the network 103, such as distributed machine learning resources and the distributed computer memory resources. The computer 102 can then call for a process 600 by which the CFX engine 101 derives a transformed counterfactual model (“CFT”) 604 that conforms to user-defined constraints, such as but not limited to monotonicity constraints.

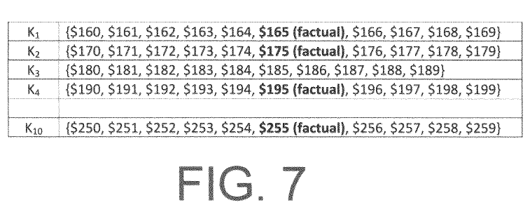

The process 600 can begin in block 606 by, without loss of generality, discretizing the graphed non-action feature (in this example the upsell offer price) into a plurality of segments Kᵢ of the price response function 400. One way of doing so could be to arrange a segment Kᵢ around each of the factual data points, such as K₁ arranged around the $165 price point and K₂ arranged around the $175 price point and so on. This would arrange K₃ around the counterfactual $185 price point. FIG. 7 depicts how Kᵢ can be mapped in computer memory 113 to the price points in this analytical approach. FIG. 7 shows a number of different segments of data including some factual output values and some counterfactual output values. The segment K₃ shown in FIG. 7 includes all counterfactual values. The non-action features/data are used to help perform the discretizing the response function into the segments. The upsell offer price above is an example of a non-action feature being used as the basis for the segmentation. In other embodiments, one or more other non-action features of the first training dataset are used as the basis for the discretizing into the segments.

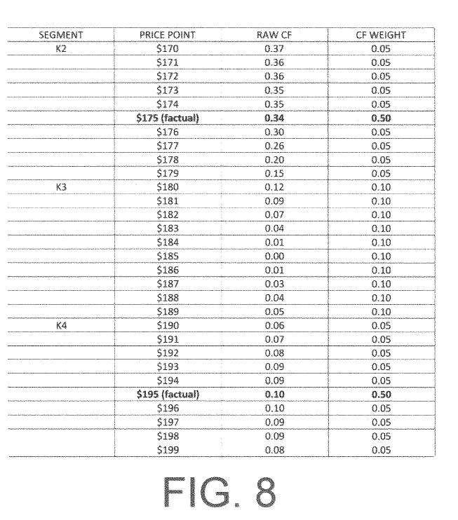

Returning to FIG. 6 and based on the selected mapping of the segments Kᵢ to the price response function 400, the process 600 in block 608 can then obtain raw counterfactual predictions from the price response function 400 for each price point in each segment Kᵢ. For example, FIG. 8 depicts these values for K₂-K₄ segments, as they can be mapped to a computer memory 113. Note that in this domain space the price response function 400 is represented by factual data only at two price points, $175 and $195. The price response function 400 is based entirely on raw counterfactual predictions in the rest of this space.

In block 610, the process 600 can then compute counterfactual weights for the raw counterfactual probabilities. Generally, the accuracy of the factual data (for example at price points $165, $175 and $195-$255) can be favored over the counterfactual predictions, and so are afforded more weight than are given to the counterfactual predictions. This analysis is particularly challenging because the counterfactuals cannot be observed. A predictive model can be established, evaluated, and continually improved to reach a desired performance. For example, one such predictive model could assume that all counterfactual weights (“W_{π}”) in the same segment Kᵢ sum to 1.0, and a factual price point has a weight value of 0.5.

$${W}_{π} f or π = 1 , … , K , {\sum }_{π} {W}_{π} = 1.$$

$${W}_{factual} = 0.5$$

$${W}_{π} = \frac{0.5}{K - 1} for π \neq f actual$$

Other predictive models can be used as well, such as decreasing counterfactual weights as the distance from a factual price point grows. Another example could be based on scaling and normalizing counterfactual revenue.

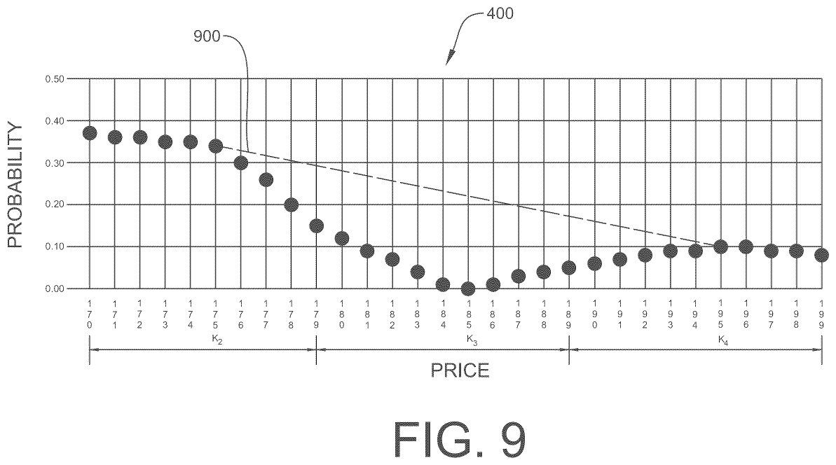

Continuing with the illustrative predictive model defined above, FIG. 8 includes the computed counterfactual weights (“CF WEIGHT”). Note that according to this predictive model, the two factual price points ($175 and $195) in the K₂-K₄ domain are weighted significantly greater than their surrounding raw counterfactual predictions. This weighting in favor of the factual predictions serves to anchor the raw counterfactuals at the two factual price points, and subordinate the raw counterfactuals therebetween. FIG. 9 is a graphical representation of the raw counterfactuals generated from the price response function 400 in this K₂-K₄ domain space. Reference line 900 depicts a linear interpolation between the two anchor points at $175 and $195, showing the variation of the raw counterfactuals in the space between them. As the K₃ segment included no factual point, all of its counterfactual points had an equal weight of 0.10. In the K₂ and K₄ segments which each had one factual point, the factual point is weighted 0.05 while the remaining counterfactual points each had an equal weight of 0.05. Within each of the segments K₁, K₂, K₃, the total weight values add up to 1.0 in this embodiment. In other embodiments, counterfactual points nearer to a factual point are weighted more than counterfactual points further from a factual point. In some embodiments, that difference in weight may depend on the distance from the factual point. For example, counterfactual point 174 would be weighted 0.07, counterfactual point 173 would be weighted 0.06, counterfactual point 172 would be weighted 0.05 counterfactual point 171 would be weighted 0.04, and counterfactual point 170 would be weighted 0.03. Counterfactual point 176 would be weighted 0.0775, counterfactual point 177 would be weighted 0.0675, counterfactual point 178 would be weighted 0.0575, and counterfactual point 179 would be weighted 0.0475.

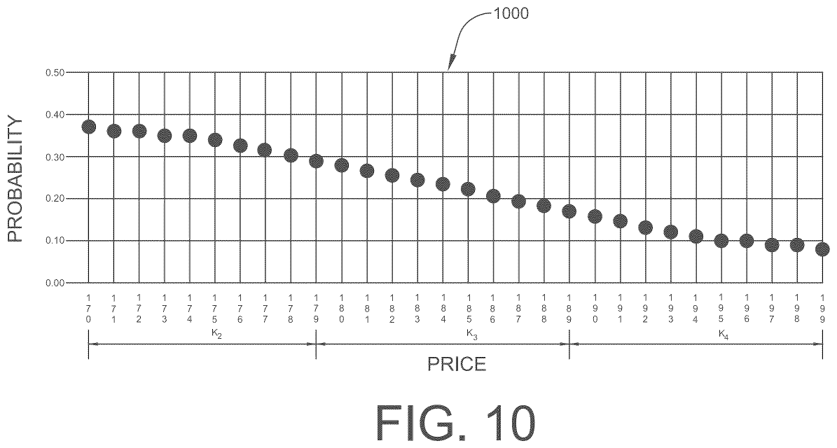

Returning to FIG. 6, the process 600 in block 612 can then perform a probabilistic regression to fit the raw counterfactuals between the $175 and $195 factual price points into a curve that conforms to user-defined constraints. In this example, the regression is programmed to enforce principles of data monotonicity. This regression is part of training a second machine learning model. In some embodiments, a separate other machine learning model is trained for each of the respective segments of the response function. For example, in a monotonic function the raw counterfactuals (demand) should decrease as the price point increases. One such monotonic transformation would be a curve fit to the linear interpolation line 900 in FIG. 9. This counterfactual transformation 1000 is depicted in FIG. 10. At this point, the CFX 101 has transformed the price response function 400 into a monotonic function 1000. Although the foregoing details concern only the K₂-K₄ segments, it will be understood that this probabilistic regression can be performed for the entire range of the price response function 400. In some embodiments, a second machine learning model is trained for the K₂ segment, a third machine learning model is trained for the K₃ segment, and a fourth machine learning model is trained for the K₄ segment. In some embodiments, a respective additional machine learning model is trained for each of these segments of the response function. The training includes applying the domain constraint on the raw counterfactual output values so that the trained model produces, as output, transformed counterfactual values. In at least some embodiments, some or each of these additional/other/second machine learning models is a respective probabilistic regression model. Each of these other ML models is trained using a respective segment (and the output values of that particular segment) from the response function.

In some embodiments, the training of the additional/other/second machine learning model includes performing a weighted multinomial logit regression. In some embodiments, the weighted multinomial logit regression includes a maximum likelihood estimator. In some embodiments, a mixed logit is used instead of a multinomial logit. The mixed logit better captures heterogeneity in output value sensitivity within a segment, in some instances. Other probabilistic regression models are used in other instances.

More generally, the historical data can include a large number of observations (such as a million more or less) from past airline bookings involving an upsell offer and a customer response. Each observation can be characterized in terms of a large number of non-action features (such as a hundred more or less) like travel, booking, and demographic attributes. The action features can reflect more than just two values, such as whether a conversion occurred for a first-class ticket upsell offer or for a business-class ticket upsell offer. The number of non-action features is generally greater, e.g., substantially greater, than the number of action features. Such an exemplary training set of data (100×1,000,000) can produce counterfactual probabilities for each counterfactual price point, like a 10×10 price grid, where each price point represents a pair of first-class and business-class prices (e.g. $500, $200). The domain-constrained weighted regression model can then be trained on a (2×101) data set consisting of the illustrative two action features (first-class price and business-class price) and 101 observations (100 counterfactual price points and one factual price point). Such a counterfactual transformation can be run in just a few seconds in the distributed computing environment by training machine learning models for all of the segments in parallel. The output can provide an aggregate constrained transformation model for a wide range of non-action features.

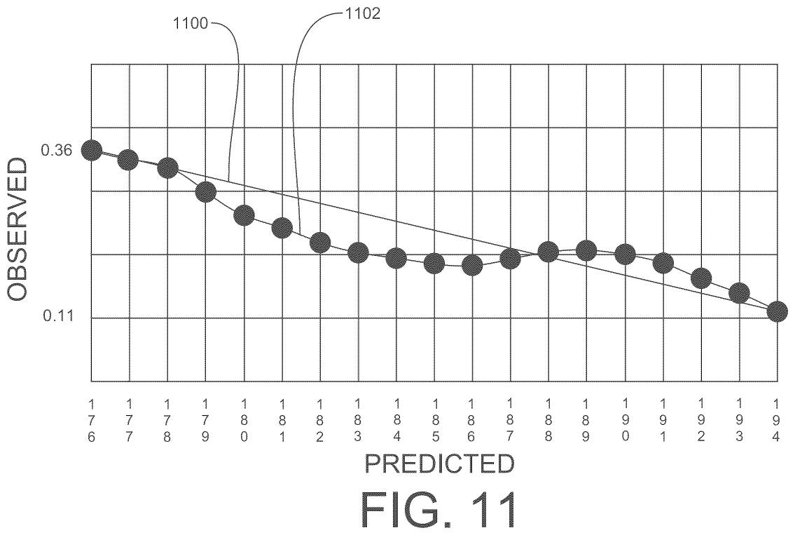

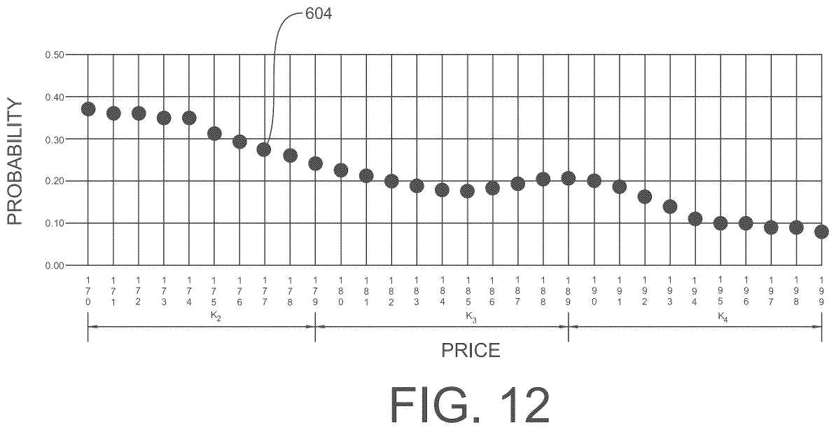

Then in block 614 of process 600 shown in FIG. 6, the monotonic function 1000 and the second/other/new machine learning model can be calibrated. This calibration begins by training the monotonic function and/or the second/other/new machine learning model on a set of data that is different from that used to originally derive the price response function 400. This removes inherent biases that can come into play from using the same data to both derive and calibrate a response function. The training results are then evaluated by comparing the empirically observed probabilities to the predicted probabilities. For example, the monotonic function 1000 in FIG. 10 predicts 31% of the upsell offers at the $176 price point will be converted. The training will result in a population of data at the $176 price point. If an empirical observation of the population determines that 31% did convert, then there is a 1:1 correspondence of predicted to observed probabilities. If the same holds true throughout the monotonically-transformed function, then plotting the predicted versus observed probabilities will yield the straight-line calibration curve 1100 in FIG. 11. For purposes of this illustrative example though, plotting the predicted versus observed probabilities results in the actual calibration curve 1102. It indicates a degree of under calibration in the space between the $179 price point and the $187 price point, and then a degree of over calibration in the space between the $188 price point and the $194 price point. The process 600 in block 614 of FIG. 6 then applies calibration factors to the pertinent counterfactuals in the monotonic function 1000 to adjust the monotonic function 1000 to better fit the actual calibration curve 1102. This transforms the monotonic function 1000 into the CFT 604 depicted in FIGS. 6 and 12. In some embodiments, such as is shown in FIGS. 6 and 12, the calibrated function crosses the domain constraint. Specifically, the CFT 604 is substantially monotonic but no longer perfectly monotonic. In other embodiments, the calibration may be held so that the calibrated function does not cross the domain constraint. For example, for the monotonic embodiment the calibrated function would not be allowed to be non-monotonic in any portion. The calibration steps were illustrated for the embodiment with monotonic constraints but may also be performed for other embodiments with other constraints such as a U-shaped response function.

The newly trained machine learning models are intended to be used thereafter for inferencing to help produce more successful probabilities and/or predictions based on a set of input data. In one embodiment, the newly trained second machine learning model performs inferencing in response to receiving an additional data set. An inference output of the inference includes probabilities of one or more events associated with the action features. In some embodiments, the inference is a probability that a customer represented by a particular data set accepts an upsell offer for a particular product at a particular price point. In some embodiments, the inference is a probability that a dosage of a particular amount of substance administered to a patient achieves a desired health intervention/effect. In some embodiments, the counterfactual engine 101 receives the inference and generates a response for presentation based on the inference. For example, based on probabilities incorporated in the inference the counterfactual engine 101 produces one or more electronic product offers to present to a customer at particular price points. These electronic offer(s) are transmitted digitally to a computer associated with the customer for presentation to the customer. In some embodiments, the electronic offers are for a set of related products that are offered to a customer each at a different price point. In some embodiments the inference probabilities are generated to be part of a digital message that is transmitted for display at a screen of a computer.

In some embodiments, the response functions, transformed response functions, and/or calibrated response functions are presented via a display on a computer screen such as a screen of the computer 102.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

It is to be appreciated that the computer system (e.g., the specialized computer 102, the CFX engine 101, and/or the processing resources) performs acts in generating the CFT 604 that cannot be performed by a human (e.g., is greater than the capability of a single human mind). For example, an amount of data processed, a speed of processing of data and/or data types of the data processed over a certain period of time can be greater, faster and different than an amount, speed and data type that can be processed by a single human mind over the same period of time. The computer system can also be fully operational towards performing one or more other functions while also performing the above-referenced counterfactual transformations for purposes of machine learning. Moreover, machine learning output generated by computer system can include information that is impossible to obtain manually by a user. For example, an amount of information included in the machine learning output and/or a variety of information included in the machine learning output can be more complex than information obtained manually by a user.

Moreover, because at least transforming counterfactuals is established from a combination of electrical and mechanical components and circuitry, a human is unable to replicate or perform processing performed by the computer system (e.g., specialized computer 102, CFX engine 101, resources) disclosed herein. For example, a human is unable to communicate data and/or process data associated with transforming a price response function 400 for a given downstream task. Furthermore, a human is unable to execute a machine learning model based on transforming a price response function to conform to user-defined constraints.

Additionally, the specialized computer 102 significantly improves the operating efficiencies of the computer system by deriving constrained probability models in response to a downstream task. Transmitting custom-tailored probability functions as disclosed herein intentionally and significantly eliminates the need to transmit large volumes of historical data. This frees up computer system processing overhead and storage capacities to attend to more important processes, generally reducing the overall cost of machine learning.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method, comprising:
training a first machine learning model with a first set of data to generate a response function and to partition the data into action features and non-action features, the response function comprising factual output values and raw counterfactual output values;
discretizing the response function into segments based on one or more of the non-action features of the first set of data; and
training a second machine learning model using a first segment of the segments and using a domain constraint on raw counterfactual output values of the first segment such that the second machine learning model produces, as output, transformed counterfactual values.

2. The computer-implemented method of claim 1, wherein a number of the non-action features in the set of data is greater than a number of the action features in the first set of data.

3. The computer-implemented method of claim 1, wherein the second machine learning model is a probabilistic regression model.

4. The computer-implemented method of claim 1, further comprising training one or more other machine learning models using one or more other segments of the segments, respectively, wherein the one or more other machine learning models are trained using the domain constraint on raw counterfactual output values of the respective one or more other segments such that the respective other machine learning model produces, as output, transformed counterfactual values.

5. The computer-implemented method of claim 1, wherein:
the second machine learning model comprises weights; and
the training of the second machine learning model using the first segment further comprises providing a first weight for a factual output value of the first segment and second weights, respectively, for counterfactual output values of the first segment, wherein the first weight is greater than each of the second weights.

6. The computer-implemented method of claim 1, wherein the domain constraint comprises a monotonicity constraint.

7. The computer-implemented method of claim 1, wherein the domain constraint comprises a U-shape for the response function.

8. The computer-implemented method of claim 1, further comprising calibrating the second machine learning model with a second set of data.

9. The computer-implemented method of claim 8, wherein the calibrating adjusts the second machine learning model to cross the domain constraint.

10. The computer-implemented method of claim 1, wherein:
the training of the first machine learning model comprises supervised training;
the first set of data comprises labeled data; and
labels of the labeled data are used to partition the data into the action features and the non-action features.

11. The computer-implemented method of claim 1, further comprising performing inference with the trained second machine learning model in response to receiving an additional data set.

12. The computer-implemented method of claim 11, wherein an inference output of the inference comprises probabilities of one or more events associated with the action features.

13. A computer program product for conforming counterfactual predictions to domain constraints, the computer program product comprising a computer readable storage medium having program instructions embodied therewith, the program instructions executable by a processor to cause a computing device to:
train a first machine learning model with a first set of data to generate a response function and to partition the data into action features and non-action features, the response function comprising factual output values and raw counterfactual output values;
discretize the response function into segments based on one or more of the non-action features of the first set of data; and
train a second machine learning model using a first segment of the segments and using a domain constraint on raw counterfactual output values of the first segment such that the second machine learning model produces, as output, transformed counterfactual values.

14. The computer program product of claim 13, wherein a number of the non-action features in the first set of data is greater than a number of the action features in the first set of data.

15. The computer program product of claim 13, wherein the second machine learning model is a probabilistic regression model.

16. The computer program product of claim 13, wherein the executed program instructions further cause the computing device to train one or more other machine learning models using one or more other segments of the segments, respectively, wherein the one or more other machine learning models are trained using the domain constraint on raw counterfactual output values of the respective one or more other segments such that the respective other machine learning model produces, as output, transformed counterfactual values.

17. The computer program product of claim 13, wherein:
the second machine learning model comprises weights; and
the training of the second machine learning model using the first segment further comprises providing a first weight for a factual output value of the first segment and second weights, respectively, for counterfactual output values of the first segment, wherein the first weight is greater than each of the second weights.

18. The computer program product of claim 13, wherein the executed program instructions further cause the computing device to calibrate the second machine learning model with a second set of data.

19. The computer program product of claim 13, wherein the executed program instructions further cause the computing device to perform inference with the trained second machine learning model in response to receiving an additional data set, wherein an inference output of the inference comprises probabilities of one or more events associated with the action features.

20. A computer system for transforming counterfactual predictions to conform to domain constraints, the computer system comprising:
one or more processors, one or more computer-readable memories, one or more computer-readable tangible storage devices, and program instructions stored on at least one of the one or more storage devices for execution by at least one or more of the processors via at least one of the one or more memories, wherein the computer system is capable of performing a method, comprising:
training a first machine learning model with a first set of data to generate a response function and to partition the data into action features and non-action features, the response function comprising factual output values and raw counterfactual output values;
discretizing the response function into segments based on one or more of the non-action features of the first set of data; and
training a second machine learning model using a first segment of the segments and using a domain constraint on raw counterfactual output values of the first segment such that the second machine learning model produces, as output, transformed counterfactual values.
